(19) United States
(12) Patent Application Publication
(10) Pub. No.: US 2014/0180759 A1
(43) Pub. Date: Jun. 26, 2014

(54) SOCIAL MARKETING SYSTEM, SERVER, AND METHOD

(71) Applicants: Kia Motors Corporation, Seoul (KR); Hyundai Motor Company, Seoul (KR)

(72) Inventor: Ki Kuk Lee, Seoul (KR)

(73) Assignees: KIA MOTORS CORPORATION, Seoul (KR); HYUNDAI MOTOR COMPANY, Seoul (KR)

(21) Appl. No.: 13/903,299

(22) Filed: May 28, 2013

(30) Foreign Application Priority Data
Dec. 20, 2012 (KR) 10-2012-0149445

(51) Int. Cl. G06Q 50/00; G06Q 30/02

(52) U.S. Cl. CPC G06Q 50/01; G06Q 30/0201
USPC 705/7.29

(57) ABSTRACT

A social marketing system, server, and method. The social marketing system includes an e-lead platform that is configured to acquire social network service (SNS) message data on a plurality of SNS systems and a social marketing server that is configured to collect the acquired SNS message data from the e-lead platform to select a target to be marketed from possible purchase customers extracted from the collected SNS message data. In addition, the social marketing server is configured to transmit a marketing message to the selected target and influencers of the target to allow marketing to be performed.

### CROSS-REFERENCE TO RELATED APPLICATION

This application is based on and claims priority from Korean Patent Application No. 10-2012-0149445, filed on Dec. 20, 2012 in the Korean Intellectual Property Office, the disclosure of which is incorporated herein in its entirety by reference.

### BACKGROUND OF THE INVENTION

1. Field of the Invention

The present invention relates to a social marketing system and method, and more particularly, to a technology of collecting data on a plurality of social network systems to perform marketing for potential purchase customers that purchase marketing products and influencers thereof.

2. Description of the Related Art

When marking products for customers, the products are marketed to invited influencers, or the products are marketed through blogs. However, since a marketing scheme has limitations in marketing activity range, marketing may not be efficient.

In recent years, users around the world share information through a social network service system. Although marketing using the social network service system has been developed, marketing cost and time may increase to reach a wider group of customers.

### SUMMARY

The present invention provides a social marketing system, server, and method that perform marketing for potential customers by automatically collecting and analyzing data, extracting a target and influencers, performing marketing, and analyzing marketing performance on a plurality of social network systems.

The present invention further provides a social marketing system, server, and method that extract potential customers who are located over a wide area within a short time by collecting a larger amount of data on a social network service system to use the collected data to extract a target for the marketing.

In addition, the present invention provides a social marketing system, server, and method that increase a marketing effect by extracting potential customers having possibility of purchasing marketing products as a target according to a purchase interest degree of consumers to perform marketing for the extracted target.

In accordance with an aspect of the present invention, a social marketing system may include: an e-lead platform configured to acquire social network service (SNS) message data on a plurality of SNS systems; and a social marketing server configured to collect the acquired SNS message data from the e-lead platform to select a target to be marketed from possible purchase customers extracted from the collected SNS message data, and transmit a marketing message to the selected target and influencers of the target to perform the marketing. The social marketing server may be configured to monitor a marketing result performed in the target and the influencers to analyze marketing performance.

In accordance with another aspect of the present invention, a social marketing server may include: a data collector configured to collect a substantial amount of social network service (SNS) data acquired by an e-lead platform; an analyzer configured to analyze a key word included in the collected SNS data to extract a possible purchase customer, and compute possible purchase indexes using the extracted possible purchase customers; a target extractor configured to extract a target to be marketed based on the possible purchase indexes using the extracted possible purchase customers and influencers corresponding to the target from human network information of the target; and a marketing message processor configured to provide a marketing message to the target or the influencers corresponding to the target. The data collector may be configured to simultaneously collect an identification (ID), human network information, and community information of a customer corresponding to the SNS data. The analyzer may be configured to analyze the collected SNS data to compute the possible purchase customers according to whether the SNS data include a purchase related key word defined with respect to a marketing product. The analyzer may be configured to apply a point to each purchase related key word defined with respect to the marketing product, and combine points of key words included in SNS data of the possible purchase customers to compute the possible purchase indexes by the extracted possible purchase customers. The target extractor may be configured to extract possible purchase customers having the possible purchase indexes by the extracted possible purchase customers equal to or greater than a preset value as the target.

In accordance with another aspect of the present invention, a social marketing server may further include: a plurality of monitors configured to monitor a marketing result based on the marketing message and analyze marketing performance. The marketing message processor may be configured to provide the marketing message to the influencers corresponding to the target, and provide the marketing message to the target based on the marketing result according to the marketing message.

In accordance with another aspect of the present invention, a social marketing method of a social marketing system may include: requesting from a plurality of social network service (SNS) systems SNS message data on the SNS systems via an e-lead platform; collecting the SNS message data acquired from the e-lead platform to extract a target to be marketed from possible purchase customers extracted from the collected SNS message data by a social marketing server; and performing marketing by transmitting a marketing message to the extracted target and the influencers of the target.

In accordance with another aspect of the present invention, a social marketing method of a social marketing system may further include: monitoring a marketing result performed in the target and the influencers to analyze marketing performance by the social marketing server.

In accordance with another aspect of the present invention, a social marketing method of a social marketing server may include: collecting a substantial amount of social network service (SNS) data acquired from an e-lead platform by a processor; analyzing a key word included in the collected SNS data to extract a possible purchase customer to compute possible purchase indexes by the extracted possible purchase customers by the processor; extracting a target to be marketed based on the possible purchase indexes by the extracted possible purchase customers and influencers corresponding to the target from human network information of the target by the processor; and providing a marketing message to the target or the influencers corresponding to the target by the processor.

The computing of the possible purchase indexes by the extracted possible purchase customers may include: analyzing, by a processor, the collected SNS data to determine whether the SNS data include a purchase related key word defined with respect to a marketing product; and computing, by the processor, the possible purchase customers based on the determination result. The computing of the possible purchase indexes by the extracted possible purchase customers may include: applying, by the processor, a point to each purchase related key word defined with respect to the marketing product; and combining, by the processor, points of key words included in SNS data of the possible purchase customers to compute the possible purchase indexes by the extracted possible purchase customers.

In accordance with another aspect of the present invention, a social marketing method of a social marketing server may further include: monitoring a marketing result according to the marketing message; and analyzing marketing performance. The providing of the marketing message may include: providing the marketing message to the influencers corresponding to the target; and providing the marketing message to the target based on the marketing result according to the marketing message.

### BRIEF DESCRIPTION OF THE DRAWINGS

The objects, features and advantages of the present invention will be more apparent from the following detailed description in conjunction with the accompanying drawings, in which:

FIG. 1 is an exemplary diagram illustrating a network configuration of a social marking system according to an exemplary embodiment of the present invention;

FIG. 2 is an exemplary diagram illustrating a configuration of a social marketing server according to an exemplary embodiment of the present invention;

FIGS. 3 to 8 are exemplary diagrams illustrating a social marketing operation of a social marketing server according to an exemplary embodiment of the present invention; and

FIG. 9 is an exemplary flowchart illustrating a social marketing method according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

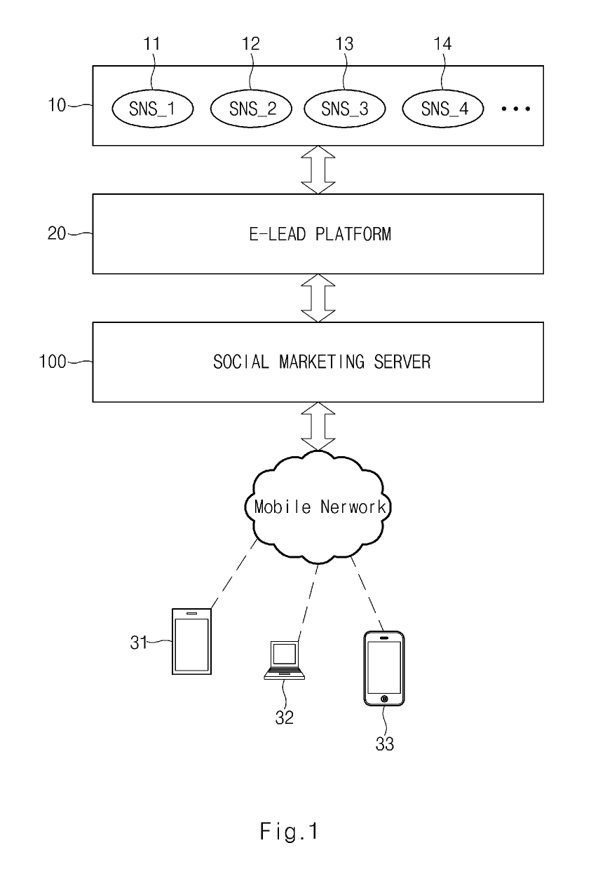

FIG. 1 is an exemplary diagram illustrating a network configuration to which a social marketing system is applied. Referring to FIG. 1, a network according to the present invention may include a plurality of Social Network Service (hereinafter referred to as ‘SNS’) systems 10, an e-lead platform 20, a social marketing server 100, and a plurality of user equipment (UE) 31, 32, and 33, wherein the user equipment may be a mobile device, a computer, or the like.

For example, the plurality of SNS systems 10 are a service system which may be configured to share information with social groups on a network such as twitter, face-book, blog, and you-tube.

The e-lead platform 20 may be a platform provided by computer system, and may be provided in order to check flow of SNS data on the SNS systems.

The e-lead platform 20 may be configured to request a plurality of SNS systems 11 to 14 to acquire SNS message data on the SNS system 10, and provide the acquired SNS message data to the social marketing server 100. In this case, information about the SNS systems 11 to 14 acquired via the e-lead platform 20 may be registered in advance. The information about the SNS systems may be added or removed according to embodiments. Specifically, the e-lead platform 20 may be implemented in the form of a software module inside the social marketing server 100. The e-lead platform 20 may be implemented in the SNS system 10 according to the embodiments. The e-lead platform 20 may be implemented in a unit separate from the social marketing server 100 and the SNS system 10. As described above, an implementation form of the e-lead platform 20 is not limited to one type, but is variously applicable according to the embodiments.

The social marketing server 100 according to the present invention may be configured to collect SNS data from the SNS systems 11 to 14 via the e-lead platform 20, analyze the collected data to extract possible purchase customers for marketing products, for example, a vehicle as a target, and directly/indirectly markets the vehicle for the target and influencers who influence purchasing of the vehicle by the target. In this case, the social marketing server 100 may be configured to perform marketing for influencers of the target to perform indirect market for the target. The social marketing server may be configured to perform direct marketing for target terminals 31, 32, and 33 through a mobile network.

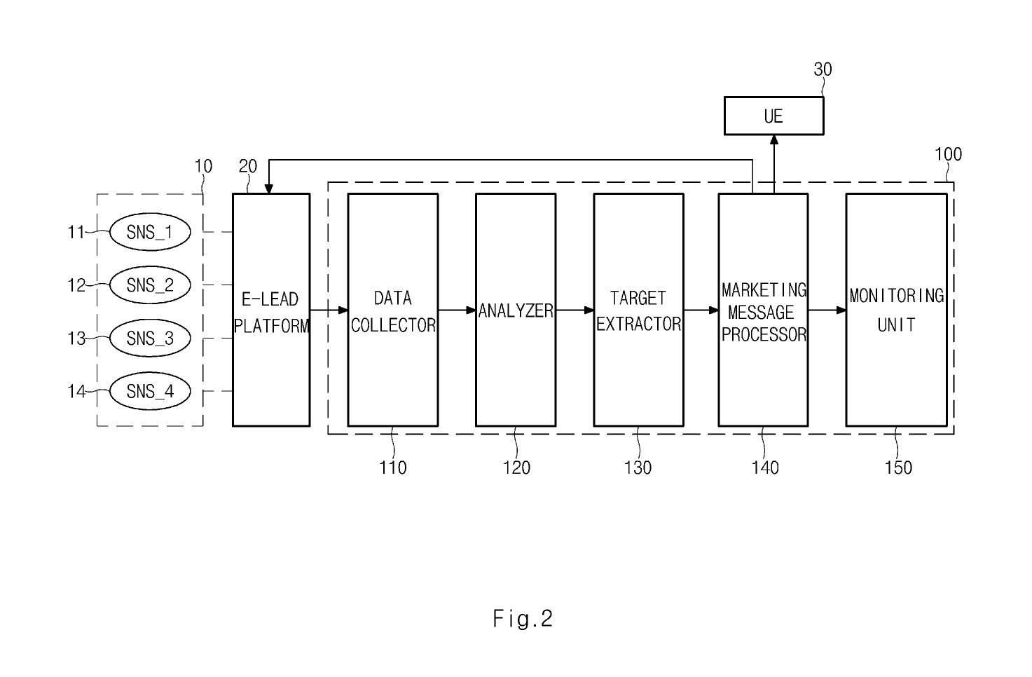

Accordingly, a configuration of the social marketing server 100 will be described in detail with reference to FIG. 2. The UE may be a terminal which may access the SNS system, and may be a terminal which transceives data through the mobile network. FIG. 2 is an exemplary diagram illustrating a configuration of a social marketing server according to an exemplary embodiment of the present invention. Referring to FIG. 2, the social marketing server 100 may include a data collector 110, an analyzer 120, a target extractor 130, and a marketing message processor 140. The social marketing system may further include a monitor.

The data collector 110 may be configured to collect data such as an SNS message acquired by the e-lead platform 20. In particular, the data collector 110 may be configured to simultaneously collect information of a customer corresponding to data, for example, ID, human network information, and community information of a corresponding customer. Since data collected by the data collector 110 is provided from a plurality of SNS systems, the collected data may be stored in a large capacity storage space.

The analyzer 120 may be configured to analyze a substantial amount of data collected by the data collector 110 to extract possible purchase customers for marketing products among the collected data. In this case, the analyzer 120 may be configured to compute possible purchase indexes by customers from the collected data, and extract possible purchase customers for marketing products based on the computed possible purchase indexes by customers.

The possible purchase index by customers may analyze key words included in an SNS message among collected data to determine whether the analyzed key words include key words associated with a marketing product, analyze response of a customer with respect to the marketing product, for example, emotion key such as good or bad, and extract the key words by customers.

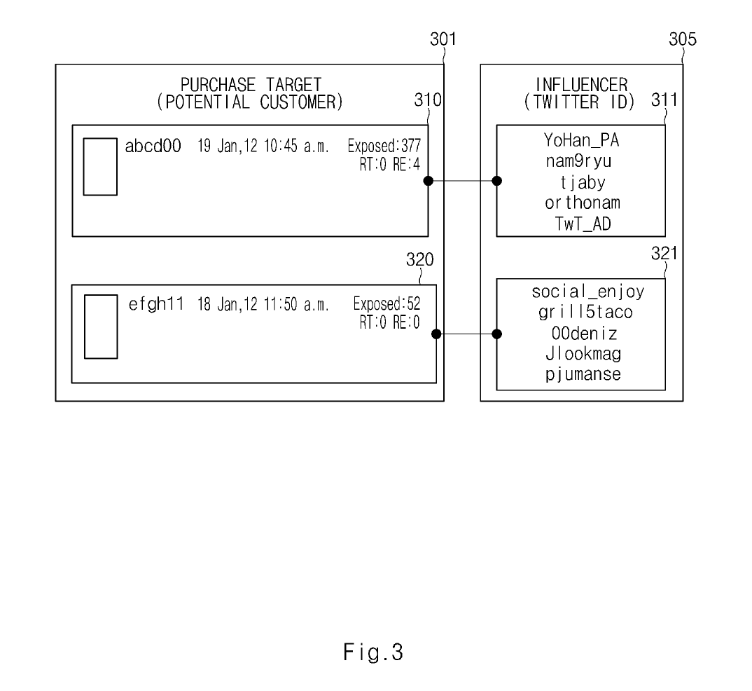

Accordingly, an operation of extracting possible purchase customers and possible purchase indexes by customers using the analyzer 120 will be described in detail with reference to FIGS. 3 to 5.

The target extractor 130 may be configured to extract a target to be marketed according to possible purchase indexes of possible purchase customers extracted from the analyzer 120. For example, the target extractor 130 may be configured to extract customers having a possible purchase index greater than a predetermined value as the target. In particular, the target extractor 130 may be configured to extract influencers for the target based on human network information of the extracted target, and extract community information for marketing for the target and influencers.

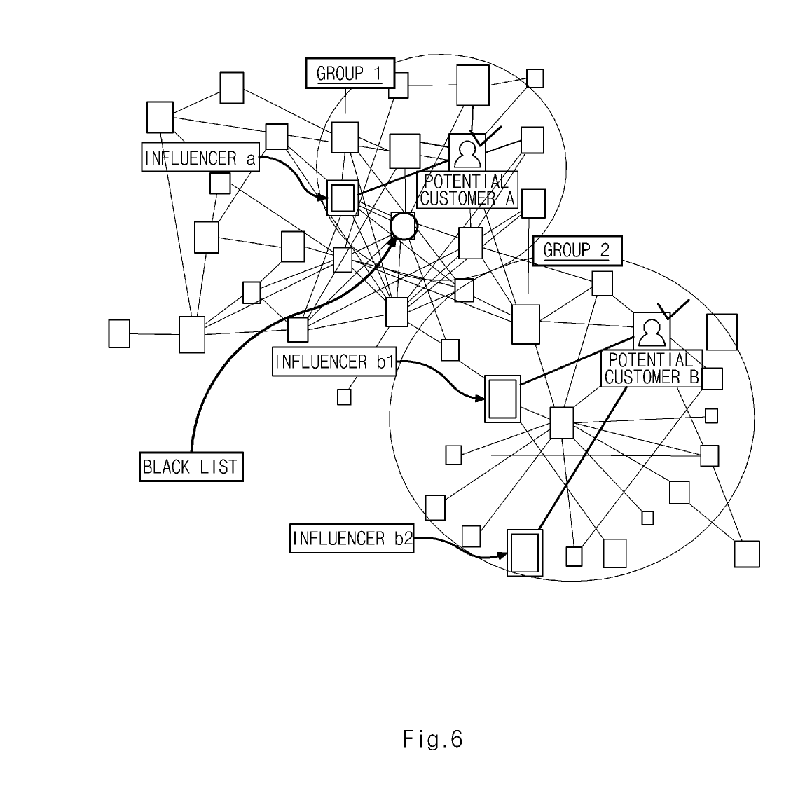

FIG. 6 illustrates an analysis model with respect to the target and the influencers extracted from the target extractor 130. The marketing message processor 140 may be configured to directly or indirectly perform marketing for the target extracted from the target extractor 130 and the influencers corresponding thereto. In particular, the marketing message processor 140 may be configured to perform indirect marketing for the target by transmitting a marketing message to the influencers. The marketing message processor 140 may be configured to perform direct marketing by transmitting the marketing message to the target.

For example, the marketing message processor 140 may primarily be configured to perform indirect marketing for the influencers, and may secondarily be configured to perform direct marketing to the target based on a result of the indirect marketing. The marketing message processor 140 may be configured to transmit a marketing message to both of the target and the influencers according to embodiments.

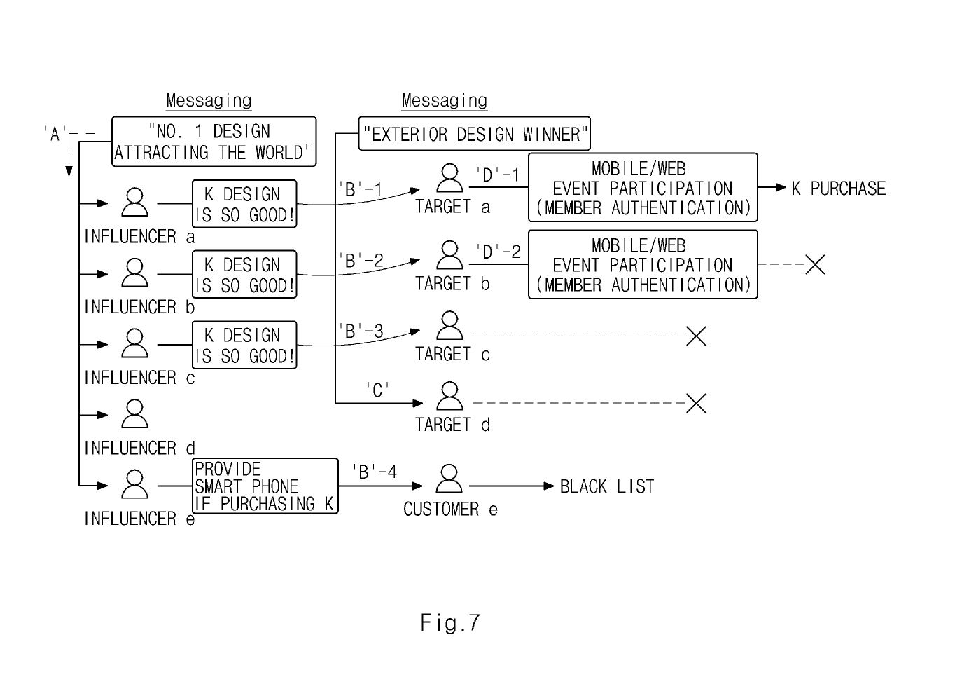

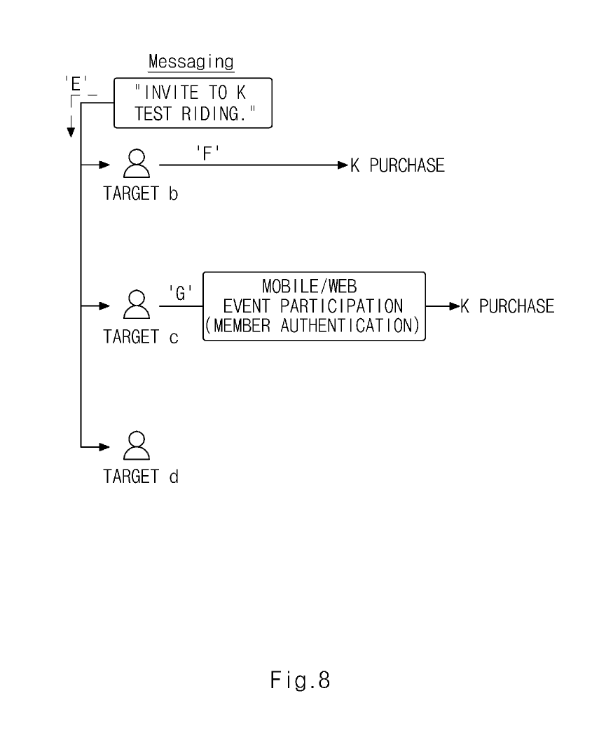

Accordingly, a marketing operation of the marketing message processor 140 will be described in detail with reference to FIGS. 7 and 8. The monitor 150 may be configured to monitor a result of direct marketing or indirect marketing by the marketing message processor 140, and may be configured to analyze transmission of a marketing message to the target or the influencers and a relation degree with respect to sales.

Furthermore, the monitor 150 may be configured to transfer a monitoring result to the marketing message processor 140. For example, after the marketing message processor 140 primarily transmits a marketing message to the influencers, the monitor 150 may be configured to monitor a marketing result with respect to the target, and transfer the monitoring result to the marketing message processor 140. Accordingly, the marketing message processor 140 may be configured to transmit a marketing message to the target based on the monitoring result from the monitor 150.

FIGS. 3 to 8 are exemplary diagrams illustrating a social marketing operation of a social marketing system according to an exemplary embodiment of the present invention. FIG. 3 illustrates an example of an operation that extracts possible purchase customers and influencers from key words included in a Twitter message of a customer.

As shown in FIG. 3, a social marketing server 100 may be configured to analyze a Twitter message 310 of a customer having a Twitter ID of abcd00 to determine that the customer may be a possible purchase customer from a sentence such as, “consider which vehicle will be bought for a wife.” In this case, the social marketing server 100 may be configured to extract information 311 of influencers of a customer having a Twitter ID of abcd00 from human network information of the customer having a Twitter ID of abcd00. For example, the social marketing server 100 may be configured to extract a customer having a Twitter ID of YoHan_PA, nam9ryu, tjaby, orthonam, or TwT_AD as the influencer of the customer having a Twitter ID of abcd00.

The social marketing server 100 may be configured to analyze a Twitter message 320 of a customer having a Twitter ID of efgh11 to determine that the customer may be a possible purchase customer from a sentence such as, “Consider selection among Hyundai Grandeur, Nissan Alita from New Camry launch field! I'm alone”. In this case, the social marketing server 100 may be configured to extract influencers 321 of a customer having a Twitter ID of efgh11 from human network information of the customer having the Twitter ID of efgh11. For example, the social marketing server 100 may be configured to extract customers having Twitter IDs of social_enjoy, grill5taco, 00deniz, Jlookmag, and pjumanse as the influencers of the customer having a Twitter ID of efgh11.

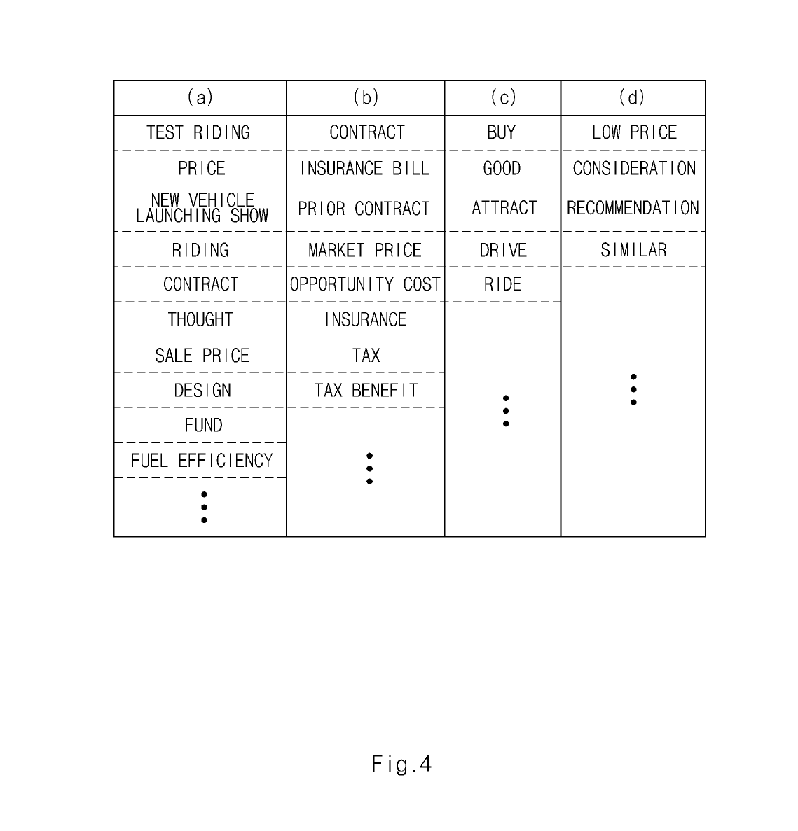

FIG. 4 illustrates previously defined purchase related key words to compute customers having purchase possibility of a marketing product, particularly, a vehicle, and possible purchase indexes by customers.

FIG. 4(a) illustrates key words associated with “information/measure>attribute”, FIG. 4(b) illustrates key words associated with “life>economy”, FIG. 4(c) illustrates key words associated with “Expression”, and FIG. 4(d) illustrates key words associated with “sensitivity/sensibility/description”.

In other words, when at least one key word by category is included in the collected data, the social marketing server 100 may be configured to determine that the customer is a possible purchase customer. as Attribute key words may include: ‘test riding’, ‘price’, ‘new vehicle launching show’, ‘riding’, ‘contract’, ‘thought’, ‘sale price’, ‘design’, ‘fund’, ‘fuel efficiency’: economic key words may include: ‘contract’, ‘insurance bill’, ‘prior contract’, ‘market price’, ‘opportunity cost’, ‘insurance’, ‘tax’, ‘tax benefit’; expression key words may include: ‘buy’, ‘good’, ‘attract’, ‘drive’, and ‘ride’: and sensitivity/sensibility/description key words may include: ‘nice price’, ‘consideration’, ‘recommendation’, and ‘similar.’

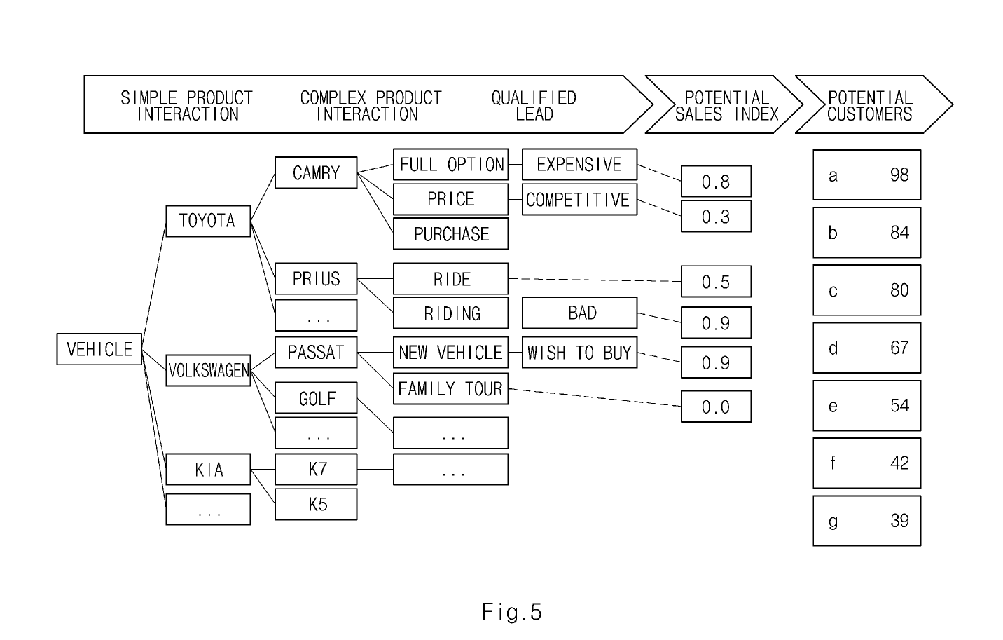

Here, the social marketing server 100 may be configured to apply a point to each key word as illustrated in FIG. 5, and compute a possible purchase index of a corresponding customer according to a combination of key words included in the collected data. For example, a point of 0.8 may be applied to a combination of key words such as ‘vehicle/Toyota/full option/expensive’, and a point of 0.0 may be applied to a combination of key words such as ‘vehicle/Volkswagen/Passat/family tour.’

The social marketing server 100 may be configured to apply a point to a combination of key words included in the collected data in the foregoing scheme, and compute possible purchase indexes by customers, for example, customer a may be 98, customer b may be 84, customer c may be 80, customer d may be 67, customer e may be 54, customer f may be 42, and customer g may be 39. In this case, for example, the social marketing server may be configured to extract a customer having a possible purchase index greater than 50 as a target to be marketed.

FIG. 6 illustrates an exemplary analysis model with respect to the target and influencers that may connect relationship between the extracted target and the influencers, and represent intimacy between the target and the influencers. For example, the intimacy may be expressed based on a thickness of a line which connects the target to the influencers. In this case, the social marketing server may be configured to set influencers formed based on the extracted target as one group to manage community information.

FIGS. 7 and 8 illustrate an exemplary marketing operation for the target and influencers. FIG. 7 illustrates an exemplary indirect marketing operation, and FIG. 8 illustrates an exemplary direct marketing operation. FIGS. 7 and 8 illustrate an exemplary operation which primarily performs indirect marketing for influencers, and secondarily performs direct marketing according to a marketing result, but the embodiment is not limited thereto. An example of marketing is not limited to one type.

Referring to FIG. 7, the social marketing server may be configured to transmit a marketing message such as, “No. 1 design attracting the world” as illustrated in ‘A’ associated with targets a, b, c, d, and e extracted in an embodiment of FIG. 5 to influencers of each target. Influencers of the targets a, b, and c may be configured to transmit a message such as, ‘K design is so good!’ to corresponding targets as illustrated in ‘B’-1, ‘B’-2, and ‘B’-3. Accordingly, some targets, for example, targets a and b may show interest in a marketing product as illustrated in ‘D’-1 and ‘D’-2, and may purchase a marketing product ‘K’ like the target a.

Meanwhile, as illustrated in ‘B’-4, when a massage such as, “provide I-pad if purchasing K” from the influencers of the target e is transmitted to the target e, the social marketing server may be configured to determine that the target e is a customer having minimal possibility (e.g., having no purchase possibility) and add the target e in a black list.

When a separate message associated with a marketing product is not transferred from the influencers like the target d, the social marketing server may be configured to perform direct marketing by directly transmitting a marketing message such as, “exterior design winner” to the target d as illustrated in ‘C’. In this case, the social marketing server 100 may be configured to transmit a marketing message and monitor a marketing result for the target.

Referring to FIG. 8, the social marketing server 100 may be configured to confirm a marketing result after indirect marketing as illustrated in FIG. 7 and perform direct marketing for targets such as targets b, c, and d which do not purchase the marketing product. That is, the social marketing server 100 may be configured to transmit a marketing message such as, “invite to K test riding” to influencers of targets b, c, and d as illustrated in ‘E’. Accordingly, the target b may purchase a marketing product as illustrated in ‘F’, and the target c may be interested in the marketing product as illustrated in ‘G’ and purchase the marketing product ‘K’. Some targets may not respond to direct marketing as in the target d, but may guide the targets a, b, and c to purchase the marketing product.

As described above, the social marketing system according to the present invention may be configured to extract a possible purchase customer based on purchase interest of a consumer, and perform marketing for the extracted target to increase a marketing effect.

An operation sequence of the social marketing system according to the present invention constructed as above is as follows.

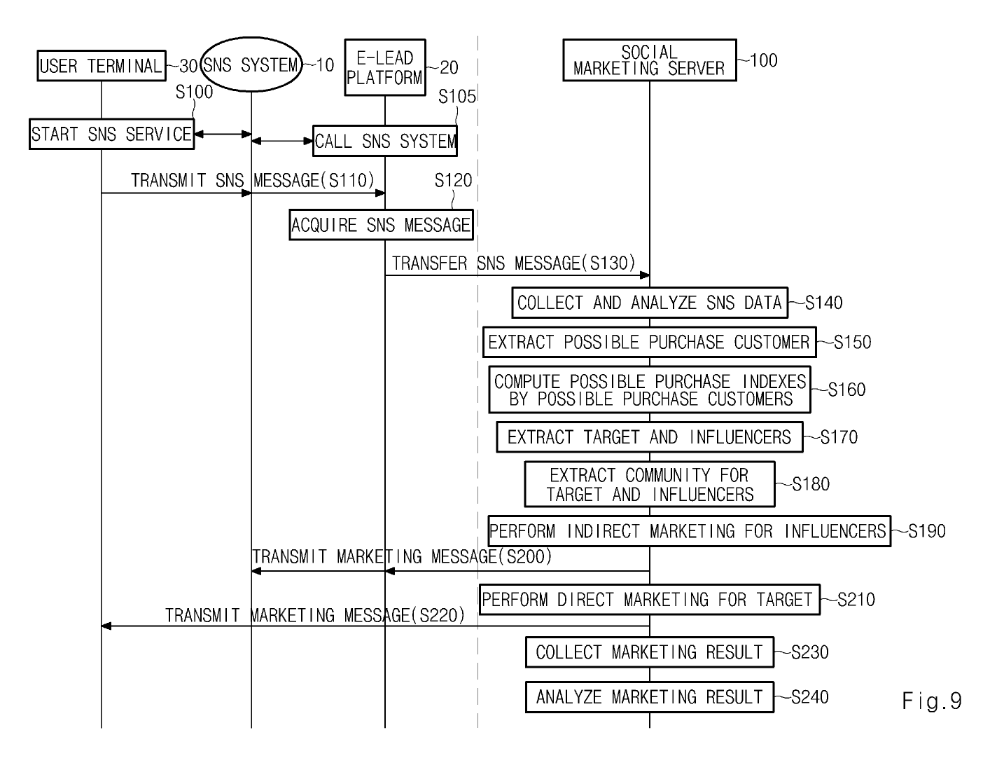

FIG. 9 is an exemplary flowchart illustrating a social marketing method according to an exemplary embodiment of the present invention. Referring to FIG. 9, in the social marketing system according to the present invention, a user accesses an SNS system to start an SNS service using a UE (S100), and transmits an SNS message to an SNS system 10 (S110).

Furthermore, the method may include requesting at least one SNS system via an e-lead platform (S105); to acquire an SNS message on the SNS system (S120); and transferring, via the e-lead platform, the acquired SNS message on the SNS system to a social marketing server (S130).

The method may further include: collecting and analyzing, by a processor, the SNS data on the at least one SNS system via the e-lead platform 20 (S140); extracting, by the processor, a possible purchase customer from an SNS data analysis result extracted in step S140 (S150); computing, by the processor, possible purchase indexes by possible purchase customers (S160); extracting, by the processor, a target to be marketed and influencers of the target based on the possible purchase indexes by possible purchase customers computed at step S160 (S170), and extracting, by the processor, a community for marketing to the target and the influencers (S180).

Furthermore, the method may include: performing, by the processor, indirect marketing with respect to the target for the influencers extracted at step S170 (S190); and transmitting, by the processor, a marketing message to a corresponding influencer (S200). The marketing message may be transmitted to an SNS system with which the influencer connects as illustrated in step S200 in the form of SMS (short message service), MMS (multi-media messaging service), or memo through a mobile network.

In addition, the method may include: performing, by the processor, direct marketing for the target extracted at step S170 (S210); and transmitting, by the processor, a marketing message to a corresponding target to do this (S220). In this case, the marketing message may be transmitted in the form of SMS, MMS, or memo through a mobile network.

The social marketing server 100 may be configured to collect a marketing result through steps S190 to S220 (S230), and analyze the marketing result (S240). The social marketing server may be configured to collect and analyze the marketing result through steps S190 and S200 after step S200.

As described above, marketing result analysis data of step S240 may be used for marketing to be performed, and the social marketing server 100 may be configured to retransmit the marketing message to a specific target based on the marketing result analysis data.

The present invention may perform marketing for potential customers by automatically collecting and analyzing data, extracting target and influencers, performing marketing, and analyzing marketing performance on a plurality of social network systems. In addition, the present invention may extract potential customers who are located over a wide area within a short time by collecting a substantial amount of data on a social network service system to use the collected data to extract a target for the marking. The present invention further may increase a marketing effect by extracting potential customers having possibility of purchasing marketing products as a target according to a purchase interest degree of consumers to perform marketing for the extracted target.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. A social marketing system, comprising:
an e-lead platform configured to acquire social network service (SNS) message data on a plurality of SNS systems; and
a social marketing server configured to collect the acquired SNS message data from the e-lead platform to select a target to be marketed from possible purchase customers extracted from the collected SNS message data, and transmit a marketing message to the selected target and influencers of the target to allow marketing to be performed.

2. The social marketing system of claim 1, wherein the social marketing server is further configured to:
monitor a marketing result performed in the target and the influencers to analyze marketing performance.

3. The social marketing system of claim 1, wherein the social marketing server includes:
a plurality of user equipment operating as a terminal and configured to access the plurality of SNS systems and transceive data through a mobile network.

4. A social marketing server, comprising:
a data collector configured to collect social network service (SNS) data acquired by an e-lead platform;
an analyzer configured to analyze a key word included in the collected SNS data to extract a possible purchase customer, and compute possible purchase indexes by the extracted possible purchase customers;
a target extractor configured to extract a target to be marketed based on the possible purchase indexes by the extracted possible purchase customers and influencers corresponding to the target from human network information of the target; and
a marketing message processor configured to provide a marketing message to the target or the influencers corresponding to the target.

5. The social marketing server of claim 4, wherein the data collector simultaneously collects an identification, human network information, and community information of a customer corresponding to the SNS data.

6. The social marketing server of claim 4, wherein the analyzer is further configured to:
analyze the collected SNS data to compute the possible purchase customers based on whether the SNS data include a purchase related key word defined with respect to a marketing product.

7. The social marketing server of claim 6, wherein the analyzer is further configured to:
apply a point to each purchase related key word defined with respect to the marketing product; and
combine points of key words included in SNS data of the possible purchase customers to compute the possible purchase indexes by the extracted possible purchase customers.

8. The social marketing server of claim 4, wherein the target extractor is further configured to:
extract possible purchase customers having the possible purchase indexes by the extracted possible purchase customers equal to or greater than a preset value as the target.

9. The social marketing server of claim 4, further comprising:
a plurality of monitors configured to monitor a marketing result according to the marketing message and analyze marketing performance.

10. The social marketing server of claim 9, wherein the marketing message processor is further configured to:
provide the marketing message to the influencers corresponding to the target; and
provide the marketing message to the target based on the marketing result according to the marketing message.

11. A social marketing method of a social marketing system, the method comprising:
acquiring, by a processor, social network service (SNS) message data on a plurality of SNS systems using an e-lead platform;
collecting, by the processor, the SNS message data acquired from the e-lead platform to extract a target to be marketed from possible purchase customers extracted from the collected SNS message data by a social marketing server; and
performing, by the processor, marketing by transmitting a marketing message to the extracted target and the influencers of the target.

12. The social marketing method of claim 11, further comprising:
monitoring, by the processor, a marketing result performed in the target and the influencers to analyze marketing performance by the social marketing server.

13. A social marketing method of a social marketing server, the method comprising:
collecting, by a processor, social network service (SNS) data acquired from an e-lead platform;
analyzing, by the processor, a key word included in the collected SNS data to extract a possible purchase customer to compute possible purchase indexes by the extracted possible purchase customers;
extracting, by the processor, a target to be marketed based on the possible purchase indexes by the extracted possible purchase customers and influencers corresponding to the target from human network information of the target; and
providing, by the processor, a marketing message to the target or the influencers corresponding to the target.

14. The social marketing method of claim 13, wherein the computing of the possible purchase indexes by the extracted possible purchase customers further includes:
analyzing, by the processor, the collected SNS data to determine whether the SNS data include a purchase related key word defined with respect to a marketing product; and
computing, by the processor, the possible purchase customers based on the determination result.

15. The social marketing method of claim 14, wherein the computing of the possible purchase indexes by the extracted possible purchase customers further includes:
applying, by the processor, a point to each purchase related key word defined with respect to the marketing product; and
combining, by the processor, points of key words included in SNS data of the possible purchase customers to compute the possible purchase indexes by the extracted possible purchase customers.

16. The social marketing method of claim 13, further comprising:
monitoring, by the processor, a marketing result based on the marketing message; and
analyzing, by the processor, marketing performance.

17. The social marketing method of claim 16, wherein the providing of the marketing message further includes:
providing, by the processor, the marketing message to the influencers corresponding to the target; and
providing, by the processor, the marketing message to the target based on the marketing result according to the marketing message.

18. A non-transitory computer readable medium containing program instructions executed by a processor, the computer readable medium comprising:
program instructions that collect social network service (SNS) data acquired from an e-lead platform;
program instructions that analyze a key word included in the collected SNS data to extract a possible purchase customer to compute possible purchase indexes by the extracted possible purchase customers;
program instructions that extract a target to be marketed based on the possible purchase indexes by the extracted possible purchase customers and influencers corresponding to the target from human network information of the target; and
program instructions that provide a marketing message to the target or the influencers corresponding to the target.

19. The non-transitory computer readable medium of claim 18, further comprising:
program instructions that analyze the collected SNS data to determine whether the SNS data include a purchase related key word defined with respect to a marketing product; and
program instructions that compute the possible purchase customers based on the determination result.

20. The non-transitory computer readable medium of claim 19, further comprising:
program instructions that apply a point to each purchase related key word defined with respect to the marketing product; and
program instructions that combine points of key words included in SNS data of the possible purchase customers to compute the possible purchase indexes by the extracted possible purchase customers.

21. The non-transitory computer readable medium of claim 18, further comprising:
program instructions that monitor a marketing result based on the marketing message; and
program instructions that analyze marketing performance.

22. The non-transitory computer readable medium of claim 19, further comprising:
program instructions that provide the marketing message to the influencers corresponding to the target; and
program instructions that provide the marketing message to the target based on the marketing result according to the marketing message.
